(19) United States
(12) Patent Application Publication
(10) Pub. No.: US 2022/0101189 A1
(43) Pub. Date: Mar. 31, 2022

(54) FEDERATED INFERENCE

(71) Applicant: VMware, Inc., Palo Alto, CA (US)

(72) Inventors: Yaniv Ben-Itzhak, Afek (IL); Shay Vargaftik, Nazareth-Illit (IL); Avishay Yanai, Herzliya (IL)

(21) Appl. No.: 17/039,294

(22) Filed: Sep. 30, 2020

(51) Int. Cl. G06N 20/00; G06N 5/04; G06F 16/245; G06F 21/60

(52) U.S. Cl. CPC G06N 20/00; G06N 5/04; H04L 2209/463; G06F 21/602; G06F 16/245

(57) ABSTRACT

In one set of embodiments, a computer system can receive a query data instance for which a prediction is requested and transmit the query data instance to a plurality of computing nodes. The computer system can further receive, from each computing node, a per-node prediction for the query data instance, where the per-node prediction is generated by the computing node using a trained version of a local machine learning (ML) model of the computing node and where the per-node prediction is encrypted in a manner that prevents the query server from learning the per-node prediction. The computer system can then aggregate the per-node predictions, generate a federated prediction based on the aggregated per-node predictions, and output the federated prediction as a final prediction result for the query data instance.

### BACKGROUND

Distributed learning is a machine learning (ML) paradigm that involves (1) training, during a training phase, a single (i.e., “global”) ML model in a distributed fashion on training datasets spread across multiple computing nodes (e.g., a first training dataset X₁ residing on a first node N₁, a second training dataset X₂ residing on a second node N₂, etc.), and (2) generating, during a query processing (or “inference”) phase, predictions for query data instances using the trained version of the global ML model. Federated learning is similar to distributed learning but includes the caveat that the training dataset of each node (referred to as the node's “local training dataset”) is private to that node; accordingly, federated learning is designed to ensure that the nodes do not reveal their local training datasets to each other, or to any other entity, during the execution of (1) and (2).

In many real-world use cases, the training phase of existing federated learning approaches—which generally requires that the nodes exchange and process model parameter information over a series of training rounds in order to train the global ML model—is subject to resource constraints such as limited network bandwidth between nodes and limited compute, memory, and/or power capacity per node. In addition, the training phase of existing federated learning approaches is vulnerable to adversarial attacks that include, e.g., deviating from the training protocol specification or poisoning the local training datasets of compromised nodes in order to corrupt the trained version of the global ML model, and analyzing the exchanged model parameter information in order to learn private details of the nodes' local training datasets. These challenges result in potentially slow training, poor model security, and poor data privacy.

### BRIEF DESCRIPTION OF THE DRAWINGS

FIG. 1 depicts a first system environment.

FIG. 2 depicts a flowchart for executing the training phase of federated learning.

FIG. 3 depicts a flowchart for executing the query processing/inference phase of federated learning.

FIG. 4 depicts a second system environment according to certain embodiments.

FIG. 5 depicts a flowchart for executing the training phase of federated inference according to certain embodiments.

FIG. 6 depicts a first flowchart for executing the query processing/inference phase of federated inference according to certain embodiments.

FIG. 7 depicts a flowchart for training an ML model to identify nodes or node subsets that are likely to generate correct predictions for query data instances according to certain embodiments.

FIG. 8 depicts a second flowchart for executing the query processing/inference phase of federated inference according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof

### 1. Overview

The present disclosure is directed to techniques for implementing a novel ML paradigm referred to herein as “federated inference.” Federated inference achieves a similar goal as federated learning in the sense that it allows (1) ML training to be performed over training datasets that are local and private to a plurality of computing nodes, and (2) predictions to be generated for query data instances in accordance with that training. However, during the training phase of federated inference, each node (or subset of nodes) can independently train its own (i.e., local) ML model using that node's local training dataset. This is in contrast to federated learning, where all nodes train a global ML model on their local training datasets in a distributed fashion.

Further, during the query processing/inference phase of federated inference, a collective “federated prediction” can be generated for a query data instance by having some or all of the nodes generate per-node predictions for the query data instance using the trained versions of their respective local ML models and by aggregating the per-node predictions. The federated prediction can then be output as the final prediction result for the query data instance. This is in contrast to federated learning, where a prediction for a query data instance is generated by simply providing the query data instance as input to the trained version of the global ML model. In certain embodiments, a privacy mechanism such as a secure multi-party computation (MPC) protocol can be employed to ensure that the identities of the nodes and/or their per-node predictions remain private throughout this query processing/inference phase.

With the general approach above, the performance, security, and privacy issues that may arise during the training phase of existing federated learning approaches can be largely avoided. The foregoing and other aspects are described in further detail in the sections that follow.

### 2. System Environment and High-Level Solution Description

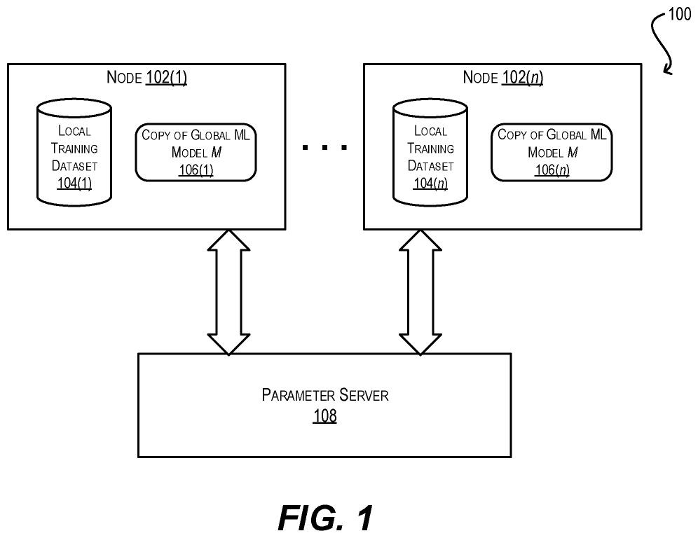

To provide context, FIG. 1 depicts a system environment 100 comprising a plurality of computing nodes 102(1)-(n) that are configured to implement conventional federated learning. As shown, each node 102(i) for i=1, n includes a local training dataset 104(i) that resides on a storage component of node 102(i) and is private to (or in other words, is only known by) that node. Local training dataset 104(i) comprises a set of m labeled training data instances d₁, . . . , dₘ where each labeled training data instance dⱼ for j=1, . . . , m includes a feature set xⱼ representing the data attributes/features of dⱼ and a label yⱼ indicating the correct prediction for dⱼ (i.e., the prediction that should ideally be generated by an ML model that has been trained on dⱼ).

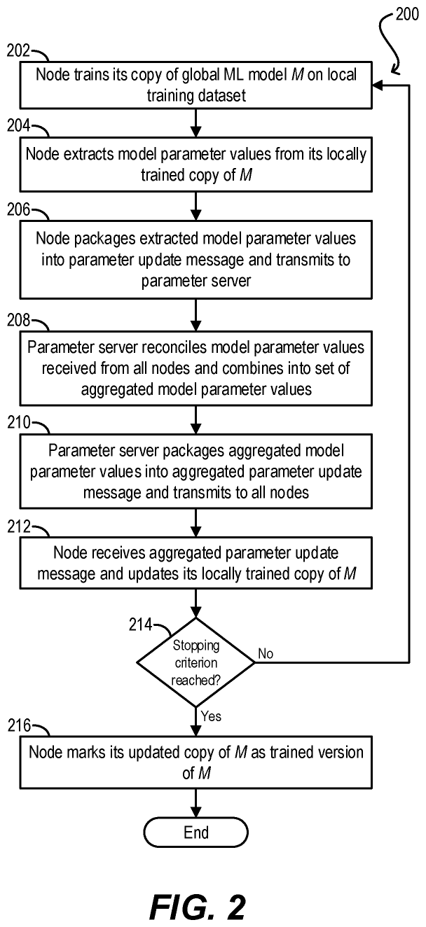

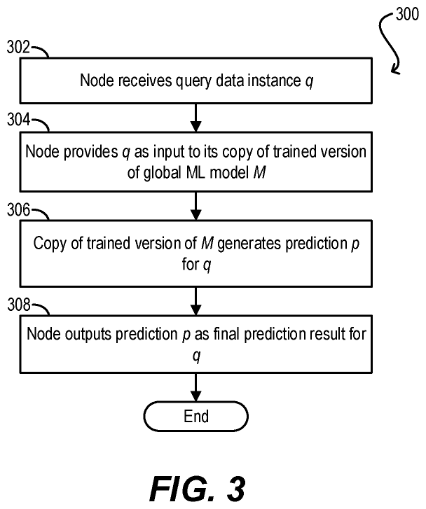

In addition to local training dataset 104(i), each node 102(i) includes a copy 106(i) of a global ML model M that is used by the nodes to carry out federated learning. To clarify how federated learning generally works, FIG. 2 depicts a flowchart 200 that may be executed by nodes 102(1)-(n) for training global ML model M on their local training datasets 104(1)-(n) in accordance with the training phase of federated learning and FIG. 3 depicts a flowchart 300 that may be executed by nodes 102(1)-(n) for processing query data instances (i.e., unlabeled data instances for which predictions are requested/desired) using the trained version of global ML model M in accordance with the query processing/inference phase of federated learning.

Starting with blocks 202 and 204 of flowchart 200, each node 102(i) can train its copy 106(i) of global ML model M on local training dataset 104(i) (resulting in a “locally trained” copy 106(i) of M) and can extract certain model parameter values from the locally trained copy that describe its structure. By way of example, if global ML model M is a random forest classifier, the model parameter values extracted at block 204 can include the number of decision trees in locally trained copy 106(i) of M and the split features and split values for each node of each decision tree. As another example, if global ML model M is a neural network classifier, the model parameter values can include the neural network nodes in locally trained copy 106(i) of M and the weights of the edges interconnecting those neural network nodes.

At block 206, each node 102(i) can package the extracted model parameter values into a “parameter update” message and can transmit the message to a centralized parameter server that is connected to all nodes (shown via reference numeral 108 in FIG. 1). In response, parameter server 108 can reconcile the various model parameter values received from nodes 102(1)-(n) via their respective parameter update messages and can combine the reconciled values into an aggregated set of model parameter values (block 208). Parameter server 108 can then package the aggregated set of model parameter values into an aggregated parameter update message and transmit this aggregated message to nodes 102(1)-(n) (block 210).

At block 212, each node 102(i) can receive the aggregated parameter update message from parameter server 108 and update its locally trained copy 106(i) of M to reflect the model parameter values included in the received message, resulting in an “updated” copy 106(i) of M. For example, if the aggregated parameter update message specifies a certain set of split features and split values for a given decision tree t₁, each node 102(i) can update t₁ in its locally trained copy 106(i) of M to incorporate those split features and split values. Because the model updates performed at block 212 are based on the same set of aggregated model parameter values sent to every node, this step results in the convergence of copies 106(1)-(n) such that these copies are identical across all nodes.

Upon updating its locally trained copy 106(i) of M, each node 102(i) can check whether a predefined criterion for concluding the training phase has been met (block 214). This criterion may be, e.g., a desired level of accuracy for M, a desired number of training rounds, or something else. If the answer at block 214 is no, each node 102(i) can return to block 202 in order to repeat blocks 202-214 as part of the next round for training M. Alternatively, in certain embodiments parameter server 108 may decide to conclude the training process at the current round; in these embodiments, parameter server 108 may include a command in the aggregated parameter update message sent to each node that instructs the node to terminate the training phase after updating its respective locally trained copy of M (not shown).

However, if the answer at block 214 is yes, each node 102(i) can mark its updated copy 106(i) of M as the trained version of global ML model M (block 216) and terminate the training phase. As indicated above, because the per-node copies of M converge at block 212, the end result of flowchart 200 is a single (and thus, global) trained version of M that is consistent across copies 106(1)-(n) of nodes 102(1)-(n) and is trained in accordance with the nodes' local training datasets (per block 202).

Turning now to flowchart 300 of FIG. 3, during the query processing/inference phase of federated learning, a given node 102(k) can receive a query data instance q, which is an unlabeled data instance (i.e., a data instance with a feature set x but without a label y) for which a prediction is requested/desired (block 302). In response, node 102(k) can provide query data instance q as input to its copy 106(k) of the trained version of global ML model M (block 304) and copy 106(k) of M can generate a prediction p for q (block 304). Finally, at block 308, node 102(k) can output p as the final prediction result for query data instance q and the flowchart can end.

As mentioned in the Background section, there are a number of challenges that make it difficult to implement the training phase of conventional federated learning (as depicted in FIG. 2) in various real-world scenarios. These challenges—which generally arise out of the need for the nodes to communicate with each other in order to converge on the trained version of global ML model M—include resource constraints (e.g., network bandwidth between nodes and per-node compute/memory/power capacity), vulnerability to attacks that compromise model security, and vulnerability to attacks that compromise the privacy of the nodes' local training datasets.

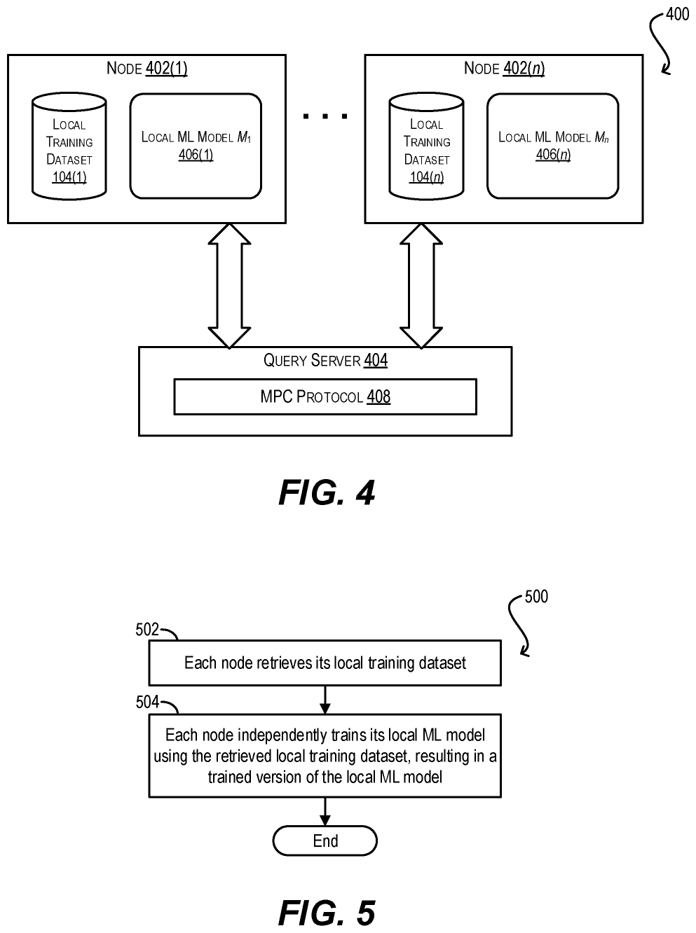

To address the foregoing and other similar issues, FIG. 4 depicts a modified version of system environment 100 of FIG. 1 (shown via reference numeral 400) comprising a set of enhanced nodes 402(1)-(n) and a query server 404 (which is distinct from parameter server 108) that are configured to implement federated inference according to certain embodiments. As noted previously, federated inference is a novel ML paradigm that achieves the same general goal as federated learning but does so without the drawbacks inherent in the distributed training required by existing federated learning approaches.

At a high level, during a training phase of federated inference, each node 402(i) for i=1, . . . , n (or a subset of these nodes) can train a local ML model Mᵢ (reference numeral 406(i)) on its local training dataset 104(i). Unlike copies 106(1)-(n) of global ML model M shown in FIG. 1, local ML models M₁, . . . , Mₙ are distinct and separate ML models that are private to their respective nodes. For example, local ML model M₁ of node 402(1) may be a random forest classifier that is only known to node 402(1), local ML model M₂ of node 402(2) may be a neural network classifier that is only known to node 402(2), local ML model M₃ of node 402(3) may be a gradient boosting classifier that is only known to node 402(3), and so on. Each node 402(i) can carry out the training of its local ML model Mᵢ in an independent manner, such that there is no need for the nodes to communicate with each other. The end result of this training phase is a trained version of local ML model Mᵢ at each node 402(i).

Then, during a query processing/inference phase of federated inference, query server 404 can receive a query data instance for which a prediction is requested or desired and can transmit the query data instance to some or all of nodes 402(1)-(n). In response, each receiving node can provide the query data instance as input to the trained version of its local ML model and thereby generate a prediction (referred to herein as a “per-node prediction”) for the query data instance. Each receiving node can then submit its per-node prediction to query server 404 in an encrypted format, such that the per-node prediction (and in some cases, the identity of the node) cannot be learned by query server 404.

Upon receiving the per-node predictions, query server 404 can aggregate them using an ensemble technique such as majority vote and generate, based on the resulting aggregation, a federated prediction for the query data instance. Because the per-node predictions are encrypted and thus not learnable/knowable by query server 404, query server 404 can perform these steps using an MPC protocol 408, which is a known cryptographic mechanism that enables an entity or group of entities to compute a function over a set of private inputs (i.e., the per-node predictions in this case) without learning/knowing the values of those inputs. In this way, query server 404 can generate the federated prediction without learning what the per-node predictions are and/or which nodes provided which per-node predictions. Finally, query server 404 can output the federated prediction as the final prediction result for the query data instance.

With federated inference, a number of benefits are achieved over federated learning. First, because the training phase of federated inference does not require communication between nodes over a series of iterative training rounds, the time and resources needed to carry out the training phase can be significantly reduced. Second, because the local ML model of each node is private to that node, it is not possible for an adversary to corrupt the local ML models of honest (i.e., uncompromised) nodes, resulting in a higher degree of model security. Third, because the nodes do not exchange model parameter information during the training phase (and only provide per-node predictions to the query server in an encrypted format during the query processing/inference phase), it is very difficult for an adversary to learn the contents of the local training datasets of honest nodes, resulting in a higher degree of data privacy. Fourth, unlike federated learning, federated inference allows accurate predictions to be obtained via the local ML models of the participating nodes without requiring any prior preparation or collaboration between those nodes.

It should be appreciated that FIGS. 1-4 are illustrative and not intended to limit embodiments of the present disclosure. For example, although query server 404 of system environment 400 is depicted as a singular server/computer system, in some embodiments query server 404 may be implemented as a cluster of servers/computer systems for enhanced performance, reliability, and/or other reasons. One of ordinary skill in the art will recognize other variations, modifications, and alternatives.

### 3. Training Phase

FIG. 5 depicts a flowchart 500 that may be executed by nodes 402(1)-(n) of FIG. 4 for carrying out the training phase of federated inference according to certain embodiments. As shown, this training phase involves retrieving, by each node 402(i), its local training dataset 104(i) (block 502) and independently training, by each node 402(i), its local ML model 406(i) on that local training dataset, thereby building a trained version of local ML model 406(i) (block 504).

The particular manner in which the training of each local ML model 406(i) is performed at block 504 will vary depending on the type of the model. For example, if local ML model 406(i) is a random forest classifier, the training at block 504 can involve repeatedly selecting random subsets of labeled training data instances from local training dataset 104(i) and fitting the selected subsets to decision trees. As another example, if local ML model 406(i) is a neural network classifier, the training at block 504 can involve, for each labeled training data instance d in local training dataset 104(i), (1) setting feature set x of d as the inputs to the neural network classifier, (2) forward propagating the inputs through the neural network classifier and generating an output, (3) computing a loss function indicating the difference between the generated output and label y of d, and (4) adjusting, via a back propagation mechanism, the weights of the edges interconnecting the neural network nodes in order to reduce/minimize the loss function.

Although flowchart 500 assumes that each individual node 402(i) trains its own local ML model, in some embodiments nodes 402(1)-(n) may be split into a number of node subsets (where each node subset comprises one or more nodes) and each node subset may train a subset-specific ML model—in other words, an ML model that is shared across the nodes of that node subset—in a distributed fashion. This alternative training approach is discussed in further detail in section (5) below.

### 4. Query Processing/Inference Phase

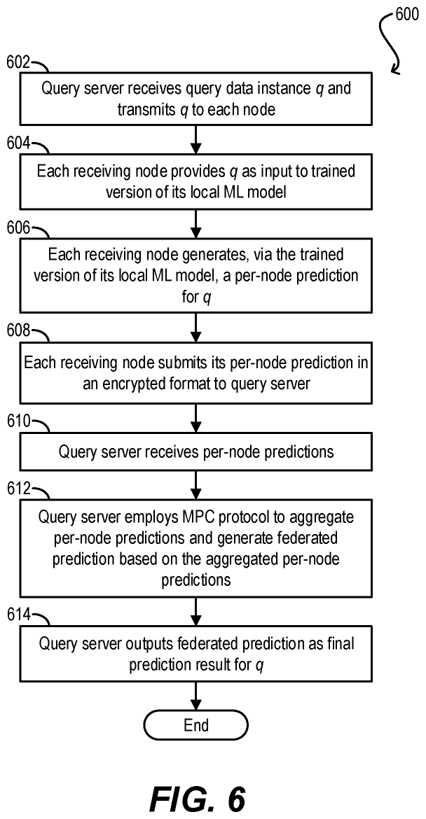

FIG. 6 depicts a flowchart 600 that may be executed by query server 404 and nodes 402(1)-(n) of FIG. 4 for carrying out the query processing/inference phase of federated inference with respect to a query data instance q according to certain embodiments. Flowchart 600 assumes that nodes 402(1)-(n) have trained their respective local ML models 402(1)-(n) via flowchart 500 of FIG. 5. In addition, flowchart 600 assumes that each and every node participates in the query processing of q (i.e., generates and provides a per-node prediction for q). In other embodiments, query server 404 may dynamically select a portion of nodes 402(1)-(n) for participation based on, e.g., the accuracy of their past per-node predictions for query data instances that have the same or similar data attributes as q (discussed in section (5) below).

Starting with block 602, query server 404 can receive query data instance q and can transmit q to each node 402(i). In response, each node 402(i) can provide query data instance q as input to the trained version of its local ML model 406(i) (block 604), generate, via model 406(i), a per-node prediction for q (block 606), and submit the per-node prediction in an encrypted format to query server 404 (such that the per-node prediction cannot be learned by query server 404) (block 608). The specific type of encryption used at block 608 can vary depending on the implementation.

At blocks 610 and 612, query server 404 can receive the per-node predictions submitted by nodes 402(1)-(n) and can employ MPC protocol 408 to aggregate the per-node predictions and generate a federated prediction based on that aggregation. As mentioned previously, an MPC protocol is a known cryptographic mechanism that enables an entity or group of entities to compute a function over a set of private inputs without knowing or learning the values of those inputs. Accordingly, MPC protocol 408 enables query server 404 generate the federated prediction based on the aggregation of the per-node predictions without knowing or learning the unencrypted value of each per-node prediction.

In one set of embodiments, the aggregation performed at block 612 can comprise tallying a vote count for each distinct per-node prediction received from nodes 402(1)-(n) indicating the number of times that per-node prediction was submitted by a node at block 608. Query server 404 can then select, as the federated prediction, the distinct per-node prediction that received the highest number of votes (or in other words, was submitted by the most nodes). For example, if nodes 402(1) and 402(2) submitted per-node prediction “A” (resulting in two votes for “A”), node 402(3) submitted per-node prediction “B” (resulting in one vote for “B”), and node 402(4) submitted per-node prediction “C” (resulting in one vote for “C”), query server 404 would select “A” as the federated prediction at block 612 because “A” has the highest vote count.

In another set of embodiments, if each per-node prediction includes an associated confidence level indicating a degree of confidence that the submitting node has in that per-node prediction, the aggregation performed at block 612 can comprise computing an average confidence level for each distinct per-node prediction. Query server 404 can then select, as the federated prediction, the distinct per-node prediction with the highest average confidence level, or provide an aggregated confidence distribution vector that indicates the average confidence level for each possible prediction. In yet other embodiments, other types of aggregation/ensemble techniques can be used.

Finally, at block 614, query server 404 can output the federated prediction as the final prediction result for query data instance q and flowchart 600 can end.

### 5. Extensions

In certain embodiments, rather than having each individual node 402(i) train its own local ML model Mᵢ as part of the training phase of federated inference, nodes 402(1)-(n) can be split into a number of node subsets and each node subset can train a subset-specific ML model in a distributed fashion (e.g., using the training approach shown in FIG. 2). In these embodiments, each subset-specific ML model will be shared by (i.e., global to) the nodes within its corresponding node subset but will be inaccessible by nodes not within that node subset. For example, assume there are six total nodes 402(1)-(6) and these nodes are split into a first node subset comprising nodes 402(1) and 402(2), a second node subset comprising nodes 402(3), 402(4), and 402(5), and a third node subset comprising node 402(6). In this scenario, nodes 402(1) and 402(2) may collectively train a first subset-specific ML model M_{S1} using the distributed approach of FIG. 2, nodes 402(3), 402(4), and 402(5) may collectively train second subset-specific ML model M_{S2} using the distributed approach of FIG. 2, and node 402(6) may train a third subset-specific ML model M_{S3} (which involves simply training local ML model 406(6)).

Then, during the query processing/inference phase of federated inference, some or all of the node subsets can generate per-subset predictions for a query data instance using their subset-specific ML models and submit the per-subset predictions to query server 404. Query server 404 can thereafter generate a federated prediction for the query data instance based on an aggregation of the per-subset (rather than per-node) predictions in a manner similar to block 612 of flowchart 600.

Further, in certain embodiments query server 404 can dynamically select, for each query data instance q received during the query processing/inference phase of federated inference, a portion of nodes 402(1)-(n) (or subsets thereof) that should participate in generating per-node or per-subset predictions for q. Query server 404 can perform this dynamic selection based on, e.g., the historical accuracy of each node or node subset in generating predictions for previous query data instances that are similar to (i.e., have the same or similar data attributes/features as) q. Query server 404 can then transmit q solely to those selected nodes or node subsets, receive their per-node or per-subset predictions, and generate a federated prediction for q based on an aggregation of the received predictions. This approach advantageously reduces the latency of the query processing/inference phase because query server 404 does not need to wait for all of the nodes/node subsets to generate and submit a per-node/per-subset prediction; instead query server 404 need only wait for those specific nodes/node subsets that are likely to generate correct predictions.

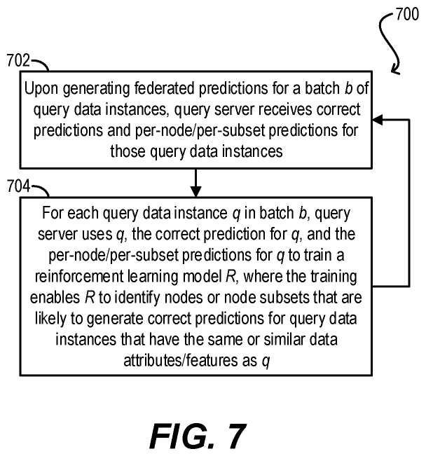

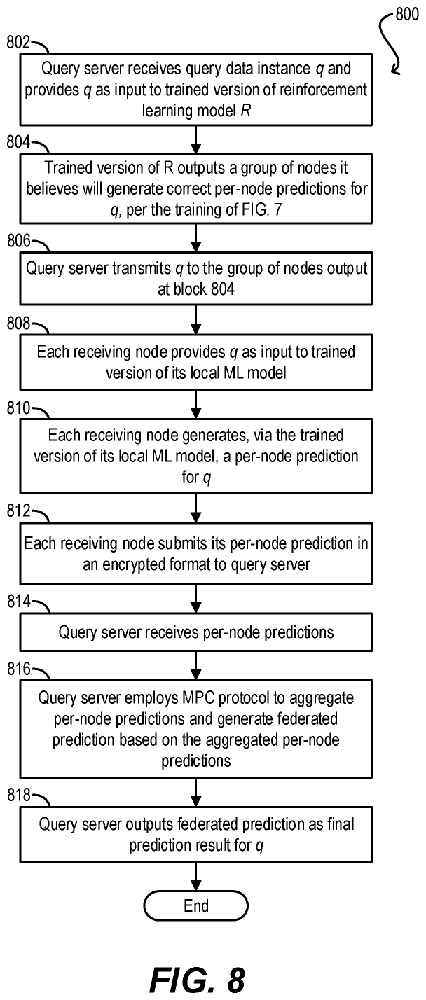

FIG. 7 depicts a flowchart 700 of a reinforcement learning-based method that query server 404 can use to learn which nodes or node subsets are best suited for generating per-node or per-subset predictions for various types of query data instances according to certain embodiments. Starting with block 702, upon generating federated predictions for a batch b of query data instances and outputting those federated predictions as the final prediction results for the query data instances per blocks 612 and 614 of FIG. 6, query server 404 can, at some later point in time, receive the correct predictions for the query data instances in batch b, as well as the per-node/per-subset predictions for each query data instance submitted by the nodes or node subsets.

In response, for each query data instance q in batch b, query server 404 can use q, the correct prediction for q, and the per-node/per-subset predictions for q as training data to train a reinforcement learning-based ML model R, where the training enables R to take as input query data instances that are similar to q and predict which nodes/node subsets will generate correct predictions for those query data instances (block 704). Query server 404 can then return to block 702 in order to train R using the next batch of query data instances.

FIG. 8 depicts a modified version of flowchart 600 of FIG. 6 (i.e., flowchart 800) that employs the trained version of reinforcement learning model R to dynamically select which nodes should participate in the query processing/inference phase of a given query data instance q according to certain embodiments. Starting with block 802, query server 404 can receive query data instance q and provide q as input to the trained version of R.

At block 804, the trained version of R can output (in accordance with its training shown in FIG. 7) a group of nodes that the model believes will generate correct per-node predictions for q. Query server 404 can then transmit q to the group of nodes output by R at block 806 (block 806) and the remainder of flowchart 800 (i.e., blocks 808-818) can proceed in a similar manner as blocks of 604-614 of FIG. 6.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, a query data instance for which a prediction is requested;
transmitting, by the computer system, the query data instance to a plurality of computing nodes;
receiving, by the computer system from each computing node in the plurality of computing nodes, a per-node prediction for the query data instance, wherein the per-node prediction is generated by the computing node using a trained version of a local machine learning (ML) model of the computing node, and wherein the per-node prediction is encrypted in a manner that prevents the query server from learning the per-node prediction;
aggregating, by the computer system, the per-node predictions received from the plurality of computing nodes;
generating, by the computer system, a federated prediction based on the aggregated per-node predictions; and
outputting, by the computer system, the federated prediction as a final prediction result for the query data instance.

2. The method of claim 1 wherein each computing node in the plurality of computing nodes independently trains its local ML model using a local training dataset that is private to the computing node.

3. The method of claim 1 wherein the aggregating and the generating are performed by the computer system using a secure multi-party computation (MPC) protocol.

4. The method of claim 1 wherein the aggregating and the generating comprises:
tallying a vote count for each distinct per-node prediction in the per-node predictions received from the plurality of computing nodes, the vote count indicating a number of times the distinct per-node prediction was received; and
selecting, as the federated prediction, a distinct per-node prediction with the highest vote count.

5. The method of claim 1 wherein the per-node prediction received from each computing node includes a confidence level indicating a degree of confidence in the per-node prediction, and wherein the aggregating and the generating comprises:
computing an average confidence level for each distinct per-node prediction in the per-node predictions received from the plurality of computing nodes; and
selecting, as the federated prediction, a distinct per-node prediction with the highest average confidence level.

6. The method of claim 1 wherein the plurality of computing nodes is selected from a larger plurality of computing nodes based on one or more data attributes of the query data instance.

7. The method of claim 6 wherein the plurality of computing nodes is selected from the larger plurality of computing nodes using an ML model trained to identify computing nodes that will generate correct per-node predictions for the query data instance.

8. A non-transitory computer readable storage medium having stored thereon program code executable by a computer system, the program code causing the computer system to execute a method comprising:
receiving a query data instance for which a prediction is requested;
transmitting the query data instance to a plurality of computing nodes;
receiving, from each computing node in the plurality of computing nodes, a per-node prediction for the query data instance, wherein the per-node prediction is generated by the computing node using a trained version of a local machine learning (ML) model of the computing node, and wherein the per-node prediction is encrypted in a manner that prevents the query server from learning the per-node prediction;
aggregating the per-node predictions received from the plurality of computing nodes;
generating a federated prediction based on the aggregated per-node predictions; and
outputting the federated prediction as a final prediction result for the query data instance.

9. The non-transitory computer readable storage medium of claim 8 wherein each computing node in the plurality of computing nodes independently trains its local ML model using a local training dataset that is private to the computing node.

10. The non-transitory computer readable storage medium of claim 8 wherein the aggregating and the generating are performed by the computer system using a secure multi-party computation (MPC) protocol.

11. The non-transitory computer readable storage medium of claim 8 wherein the aggregating and the generating comprises:
tallying a vote count for each distinct per-node prediction in the per-node predictions received from the plurality of computing nodes, the vote count indicating a number of times the distinct per-node prediction was received; and
selecting, as the federated prediction, a distinct per-node prediction with the highest vote count.

12. The non-transitory computer readable storage medium of claim 8 wherein the per-node prediction received from each computing node includes a confidence level indicating a degree of confidence in the per-node prediction, and wherein the aggregating and the generating comprises:
computing an average confidence level for each distinct per-node prediction in the per-node predictions received from the plurality of computing nodes; and
selecting, as the federated prediction, a distinct per-node prediction with the highest average confidence level.

13. The non-transitory computer readable storage medium of claim 8 wherein the plurality of computing nodes is selected from a larger plurality of computing nodes based on one or more data attributes of the query data instance.

14. The non-transitory computer readable storage medium of claim 13 wherein the plurality of computing nodes is selected from the larger plurality of computing nodes using an ML model trained to identify computing nodes that will generate correct per-node predictions for the query data instance.

15. A computer system comprising:
a processor; and
a non-transitory computer readable medium having stored thereon program code that, when executed, causes the processor to:
receive a query data instance for which a prediction is requested;
transmit the query data instance to a plurality of computing nodes;
receive, from each computing node in the plurality of computing nodes, a per-node prediction for the query data instance, wherein the per-node prediction is generated by the computing node using a trained version of a local machine learning (ML) model of the computing node, and wherein the per-node prediction is encrypted in a manner that prevents the query server from learning the per-node prediction;
aggregate the per-node predictions received from the plurality of computing nodes;
generate a federated prediction based on the aggregated per-node predictions; and
output the federated prediction as a final prediction result for the query data instance.

16. The computer system of claim 15 wherein each computing node in the plurality of computing nodes independently trains its local ML model using a local training dataset that is private to the computing node.

17. The computer system of claim 15 wherein the aggregating and the generating are performed using a secure multi-party computation (MPC) protocol.

18. The computer system of claim 15 wherein the program code that causes the processor to aggregate the per-node predictions and generate the federated prediction comprises program code that causes the processor to:
tally a vote count for each distinct per-node prediction in the per-node predictions received from the plurality of computing nodes, the vote count indicating a number of times the distinct per-node prediction was received; and
select, as the federated prediction, a distinct per-node prediction with the highest vote count.

19. The computer system of claim 15 wherein the per-node prediction received from each computing node includes a confidence level indicating a degree of confidence in the per-node prediction, and wherein the program code that causes the processor to aggregate the per-node predictions and generate the federated prediction comprises program code that causes the processor to:
compute an average confidence level for each distinct per-node prediction in the per-node predictions received from the plurality of computing nodes; and
select, as the federated prediction, a distinct per-node prediction with the highest average confidence level.

20. The computer system of claim 15 wherein the plurality of computing nodes is selected from a larger plurality of computing nodes based on one or more data attributes of the query data instance.

21. The computer system of claim 20 wherein the plurality of computing nodes is selected from the larger plurality of computing nodes using an ML model trained to identify computing nodes that will generate correct per-node predictions for the query data instance.
